(19) United States
(12) Patent Application Publication
(10) Pub. No.: US 2005/0167963 A1
(43) Pub. Date: Aug. 4, 2005

(54) Energy absorbing steering column geometric sleeve

(76) Inventors: Mirjana Jurik, Rochester Hills, MI (US); Mohan Bhogineni, Troy, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/768,564

(22) Filed: Jan. 30, 2004

(51) Int. Cl. B62D 1/11

(52) U.S. Cl. 280/777

(57) ABSTRACT

An energy absorbing steering column sleeve includes a tubular body. The tubular body is defined by a plurality of channels extending from an end of the tubular body to an opposite end thereof.

### FIELD OF THE INVENTION

The present invention relates to steering columns, and more particularly to an energy absorbing geometric sleeve for a steering column.

### BACKGROUND OF THE INVENTION

A typical steering column includes an upper mounting bracket that is coupled to the body of the motor vehicle and a lower mounting bracket that is coupled to the vehicle wall and steering control at one end and the steering wheel assembly at an opposite end. During an impact event, the upper mounting bracket will move relative to the lower mounting bracket. A steering column jacket is mounted between the lower mounting bracket and the upper mounting bracket. This steering column jacket is conventionally a solid piece of material, typically steel, that buckles as the upper mounting bracket moves relative to the lower mounting bracket, thereby absorbing a set amount of energy from the impact event. While this steering column jacket has served exceptionally well in the past, automobile manufacturers are continuously seeking improvements.

### SUMMARY OF THE INVENTION

An energy absorbing steering column sleeve includes a tubular body. The tubular body is defined by a plurality of channels extending from an end of the tubular body to an opposite end thereof. The plurality of channels have a geometric honeycomb structure such as a diamond, triangular, rectangular, or a wiremesh cross-section.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of an exemplary steering column having an energy absorbing sleeve constructed according to the principles of the present invention;

FIG. 2A is an end view of the energy absorbing sleeve of the present invention;

FIG. 2B is an end view of a second energy absorbing sleeve of the present invention;

FIG. 2C is an end view of a third energy absorbing sleeve of the present invention;

FIG. 3 is a side view of the energy absorbing sleeve prior to an impact event; and

FIG. 4 is a side view of the energy absorbing sleeve shown in FIG. 3 after an impact event.

### DETAILED DESCRIPTION OF THE PREFERRED EMBODIMENTS

The following description of the preferred embodiment(s) is merely exemplary in nature and is in no way intended to limit the invention, its application, or uses.

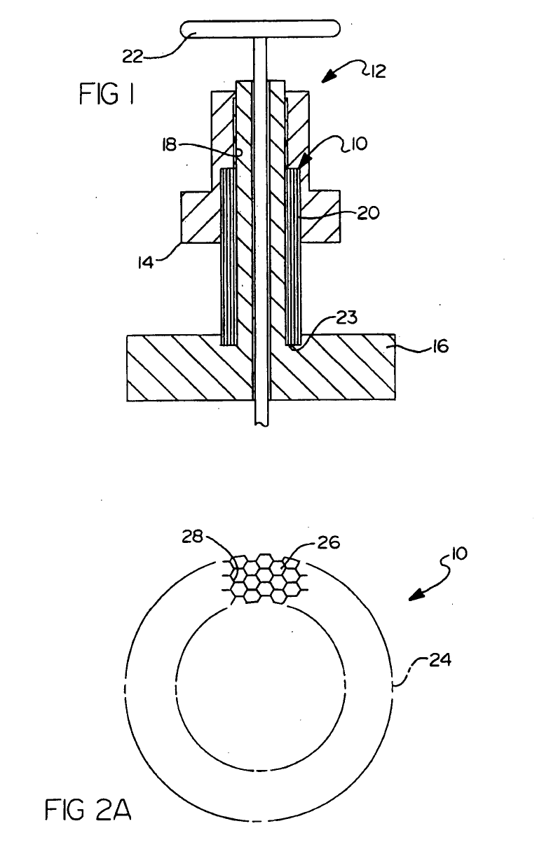

Referring to FIG. 1, there is shown an energy absorbing sleeve 10 in operative association with an exemplary steering column 12. The steering column 12 includes an upper mounting bracket 14 and a lower mounting bracket 16. The upper mounting bracket 14 is adapted to be mounted to the body of a motor vehicle (not shown). The upper mounting bracket 14 defines an aperture 18 having a portion having an increased area, generally indicated by reference numeral 20, for receiving the energy absorbing sleeve 10 therein.

The lower mounting bracket 16 extends through the aperture 18 of the upper mounting bracket 14 and is coupled to a steering wheel 22 at an end thereof, and is coupled to a wheel assembly (not shown) of the motor vehicle at an opposite end thereof. The lower mounting bracket 16 includes a portion 23 for receiving an end of the energy absorbing sleeve 10 therein. In this way, the energy absorbing sleeve 10 is trapped between the upper mounting bracket 14 and the lower mounting bracket 16.

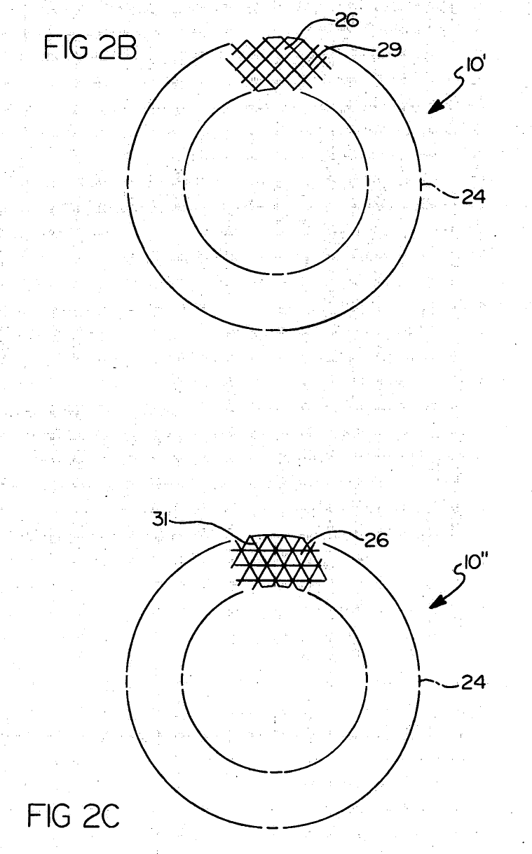

Turning to FIG. 2A, the energy absorbing sleeve 10 is generally tubular in shape with an inner diameter slightly less than the outer diameter of the lower mounting bracket 16. The energy absorbing sleeve 10 has a body 24 defined by a honeycomb structure 26. The honeycomb structure 26 includes a plurality of hexagonal channels 28 stacked one atop another. Each hexagonal channel 28 extends along the entire length of the body 24. While in the particular example provided the honeycomb structure 26 is defined by hexagonally shaped channels, it is to be understood that variously other shaped channels may be employed. For example, with reference to FIG. 2B, a second energy absorbing sleeve 10′ includes the honeycomb structure 26 defined by diamond shaped channels 29. With reference to FIG. 2C, a third energy absorbing sleeve 10″ includes the honeycomb structure 26 defined by triangular shaped channels 31. Other shapes may include a wiremesh or rectangular shape. The energy absorbing sleeve 10 is preferably made from an aluminum, though various other metals and other materials may be employed.

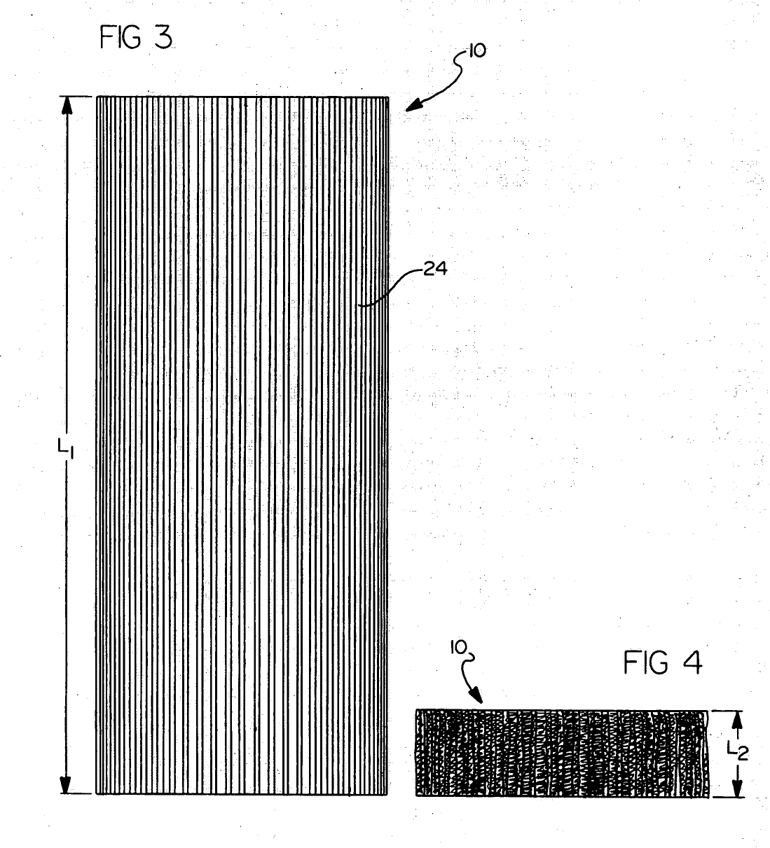

With reference to FIG. 3, the energy absorbing sleeve 10 has a length L1 when in an uncompressed configuration (e.g., prior to an impact event). When the motor vehicle (not shown) is involved in an impact event, the upper mounting bracket 14 moves relative to the lower mounting bracket 16. During this movement, the energy absorbing sleeve 10 is compressed between the upper mounting bracket 14 and the lower mounting bracket 16. With reference to FIG. 4, the energy absorbing sleeve 10 will collapse to a collapsed configuration having a length L2. The length L2 is less than the length L1. As can be seen in FIG. 4, the energy absorbing sleeve 10 collapses uniformly and does not buckle. Collapsing of the energy absorbing sleeve 10 absorbs energy from the impact event. The amount of energy absorbed may be altered by changing the material of the energy absorbing sleeve 10, by increasing the wall thickness of the hexagonal channels 28 and by increasing the number of hexagonal channels 28. The loads which the energy absorbing sleeve 10 may absorb range from very high (e.g., more than 2000 lbs.) to very low (e.g., approximately 50 lbs.). Moreover, the honeycomb structure 26 makes the energy absorbing sleeve 10 extremely lightweight as compared to solid metal prior art sleeves.

The description of the invention is merely exemplary in nature and, thus, variations that do not depart from the gist of the invention are intended to be within the scope of the invention. Such variations are not to be regarded as a departure from the spirit and scope of the invention.

1. An energy absorbing steering column sleeve comprising:
a tubular body defined by a plurality of channels extending from an end of said tubular body to an opposite end thereof.

2. The energy absorbing steering column sleeve of claim 1, wherein said channels have a hexagonal cross section.

3. The energy absorbing steering column sleeve of claim 1, wherein said channels have a diamond cross section.

4. The energy absorbing steering column sleeve of claim 1, wherein said channels have a triangular cross section.

5. The energy absorbing steering column sleeve of claim 1, wherein said tubular body is made of aluminum.

6. The energy absorbing steering column sleeve of claim 1, wherein said tubular body collapses substantially uniformly when compressed.

7. A steering column for a motor vehicle comprising:
an upper mounting bracket adapted to be mounted to the motor vehicle;
a lower mounting bracket extending from said upper mounting bracket; and
a sleeve mounted between said lower mounting bracket and said upper mounting bracket, said sleeve having a plurality of hollow channels;
wherein during an impact event with the motor vehicle, said upper mounting bracket compresses said sleeve and said sleeve collapses, thereby absorbing energy from the impact event.

8. The energy absorbing steering column sleeve of claim 7, wherein said channels have a hexagonal cross section.

9. The energy absorbing steering column sleeve of claim 7, wherein said channels have a diamond cross section.

10. The energy absorbing steering column sleeve of claim 7, wherein said channels have a triangular cross section.

11. The energy absorbing steering column sleeve of claim 7, wherein said tubular body is made of aluminum.

12. The energy absorbing steering column sleeve of claim 7, wherein said tubular body collapses substantially uniformly when compressed.
